(19) United States
(12) Patent Application Publication
(10) Pub. No.: US 2015/0059167 A1
(43) Pub. Date: Mar. 5, 2015

(54) ATTACHMENT DEVICE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: JUN-HUI YU, Shenzhen (CN); DAI-PENG ZHU, Shenzhen (CN); LONG-PING QU, Shenzhen (CN); YU-TSAN CHENG, New Taipei (TW); CHIEN-LIANG CHOU, New Taipei (TW); SHIN-WEN CHEN, New Taipei (TW)

(21) Appl. No.: 14/467,895

(22) Filed: Aug. 25, 2014

(30) Foreign Application Priority Data
Aug. 28, 2013 (CN) 2013103804128

(51) Int. Cl. H01B 13/00

(52) U.S. Cl. CPC H01B 13/0026
USPC 29/745

(57) ABSTRACT

An attachment device includes an exhaust, a connecting pipe, and an adhering head. The adhering head includes an adhering surface, and the adhering surface defines a number of evenly spaced adhering holes for adhering a conductive adhesive film. The connecting pipe air-tightly connects the exhaust to the adhering head.

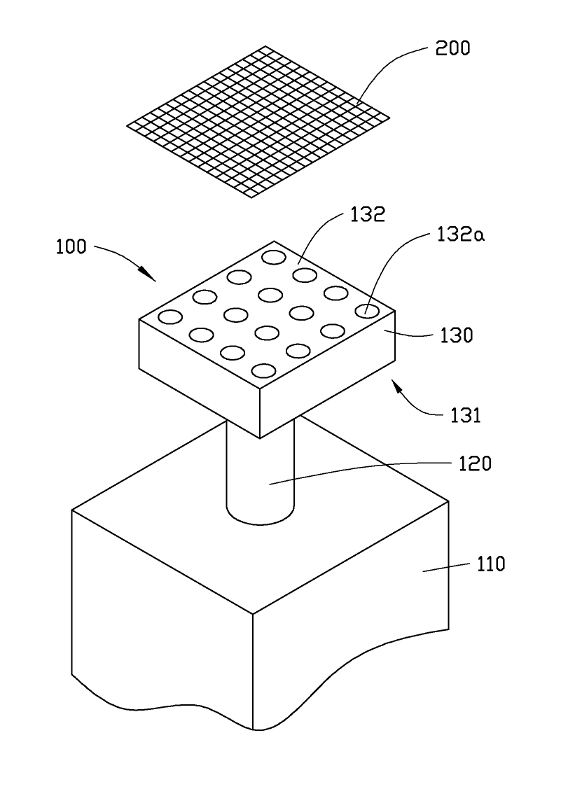

### FIELD

The present disclosure relates to an attachment device.

### BACKGROUND

Conductive adhesive films usually ground electronic devices. When assembling, the conductive adhesive film is first adhered to an attachment device, and then the conductive adhesive film is assembled to the electronic device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The FIGURE is a schematic, isometric view of an attachment device according to an exemplary embodiment of the present disclosure.

### DETAILED DESCRIPTION

The FIGURE illustrates an attachment device 100. The attachment device 100 is configured for attaching a conductive adhesive film 200 to an electronic device. In this embodiment, the conductive adhesive film 200 is a conductive fabric. The conductive fabric includes a cloth coated with conductive glue.

The attachment device 100 includes an exhaust 110, a connecting pipe 120 and an adhering head 130. The connecting pipe 120 is made of stainless steel and forms an airtight connection between the exhaust 110 and the adhering head 130.

The shape of the adhering head 130 corresponds to the shape of the conductive adhesive film 200. In this embodiment, the conductive adhesive film 200 is square, and the adhering head 130 is a hollow cube. The adhering head 130 includes a connecting surface 131 and an adhering surface 132 opposite to the connecting surface 131. The connecting surface 131 defines a connecting hole connected airtight to the connecting pipe 120.

The adhering surface 132 is a flat surface, and defines a number of evenly spaced adhering holes 132a. The adhering holes 132a are equal to each other. The adhering holes 132a form an array on the adhering surface 132. In another embodiment, when the conductive adhesive film 200 is round, the adhering holes 132a can also be distributed circularly.

The size of the adhering holes 132a is determined by the height of the conductive adhesive film 200 for avoiding forming wrinkles on the conductive adhesive film 200 when the conductive adhesive film 200 is adhered on the adhering surface 132. In this embodiment, the height of the conductive adhesive film 200 is about 0.05 millimeters, the adhering holes 132a forms a 4×4 array, and the diameter of each adhering hole 132a is about 1 millimeter.

The adhering head 130 is made of rigid material, such as white polyoxymethylene (POM). The adhering head 130 will not deforms when adhering the conductive adhesive film 200.

When in use, the exhaust 110 creates a vacuum in the adhering holes 132a and the adhering holes 132a absorb the conductive adhesive film 200. As the adhering holes 132a are evenly spaced, the adhering strength of the adhering holes 132a will be evenly applied on the conductive adhesive film 200 for avoiding wrinkles from being formed on the conductive adhesive film 200.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An attachment device comprising:
an exhaust;
an adhering head comprising an adhering surface, the adhering surface defining a number of evenly spaced adhering holes for adhering a conductive adhesive film; and
a connecting pipe air-tightly connecting the exhaust to the adhering head.

2. The attachment device of claim 1, wherein the adhering holes are equal in size.

3. The attachment device of claim 1, wherein the adhering head further comprises a connecting surface opposite to the adhering surface and connected to the connecting pipe.

4. The attachment device of claim 1, wherein the height of the conductive adhesive film is about 0.05 millimeters, the adhering holes form a 4*4 array, and a diameter of each adhering hole is about 1 millimeter.

5. The attachment device of claim 1, wherein the connecting pipe is made of stainless steel.

6. The attachment device of claim 1, wherein the adhering head is made of rigid material.

7. The attachment device of claim 6, wherein the adhering head is made of white polyoxymethylene.
